(19) United States
(12) Patent Application Publication
(10) Pub. No.: US 2021/0109750 A1
(43) Pub. Date: Apr. 15, 2021

(54) CODE QUALITY LINKED REWARDS

(71) Applicant: Visa International Service Association, San Francisco, CA (US)

(72) Inventors: Ila Malde, Foster City, CA (US); Vara Prasad Beerakam, Singapore (SG); Karthik Venkatarman, Singapore (SG); Ze Hong Sean Tay, Singapore (SG); Giriraj Gujar, Singapore (SG)

(21) Appl. No.: 16/597,675

(22) Filed: Oct. 9, 2019

(51) Int. Cl. G06F 8/77; G06F 8/33; G06F 11/36

(52) U.S. Cl. CPC G06F 8/77; G06F 11/3664; G06F 8/33

(57) ABSTRACT

The solution provides an unbiased code quality performance evaluation to a development manager. The report can be used as a tool to reward individuals whose code quality measurements exceeds the given thresholds, and perform root cause analysis with individuals whose code quality measurements are falling below the given thresholds. A method first receives a submission from a developer for logging an application program to be used in a deployment environment. A database is constructed with data fields associated with the application program. The code coverage of the application program is determined, as well as a test coverage value. A plurality of a plurality of reliability parameters are assigned, along with a plurality of security parameters associated with the application program. The code quality grade is calculated as a function of the plurality of the reliability parameters, the plurality of security parameters, and the maintainability parameters.

### TECHNICAL FIELD

Embodiments discussed herein generally relate to identifying application or program lifecycle and quality.

### BACKGROUND

Developers and programmers write or design software or application programs on small and big projects with varying complexity. Some pieces of code are meant to update existing application programs while others may be part of an application programming interface (API).

In some current practices, developers' codes or program submissions are entered or saved in a central repository for later retrieval or evaluation. For example, in a very high level, the codes started from design or conception stages before the actual coding, troubleshooting, and compiling. Once it's compiled, the codes may go through other (e.g., alpha, beta, etc.,) testing before they are placed in production. In such example, diagram 100 in FIG. 1, illustrate some of the current approaches to software development pipeline or flow.

However, this lifecycle of developed codes typical ends when the program is in deployed in production, and could possibly restart if defects are found in production, or business requiring further enhancements. In addition, various points of completion or milestones in the development do not yield information about the code itself, such as intrinsic values (e.g., how much time a developer has spent on developments or how many times the developer has checked in codes or running debugging, etc.,) and extrinsic values (e.g., return of investment (ROI) value of the code, etc.,) are lost in the process. Unfortunately, current system fails to provide a convenient or transparent view on the codes because. poorly written code can be costly to fix after the fact.

Moreover, current practices perform code quality reviews based on bug reports, bug fixes, etc. Sometimes, the developers are not aware of some of these findings and even when they are aware of them, the findings are too late to alter any change to the behaviors in the coding. Moreover, certain code may be subjected to security issues, but developers may not be aware of these issues until much later.

Therefore, embodiments attempt to create a technical solution to address the deficiencies of the challenges above, and drive a cultural change, by rewarding developers for writing quality code, which overtime is expected to become second nature.

### SUMMARY

Embodiments create a technical solution to the above challenges by building a comprehensive code quality rewards system for submission, testing and analysis of codes, software, and application programs. Aspects of embodiments may further create data structures to provide data points available for monitoring the progress of the code development by grading the codes and alert the developers and/or his or her managers if certain threshold is reached (e.g., to award good/high quality code and to assist developers with lower quality code). Moreover, such system may provide a transparent view for both developers and supervisors/managers to know the quality of the code development and lifecycle.

### BRIEF DESCRIPTION OF THE DRAWINGS

Persons of ordinary skill in the art may appreciate that elements in the figures are illustrated for simplicity and clarity so not all connections and options have been shown. For example, common but well-understood elements that are useful or necessary in a commercially feasible embodiment may often not be depicted in order to facilitate a less obstructed view of these various embodiments of the present disclosure. It may be further appreciated that certain actions and/or steps may be described or depicted in a particular order of occurrence while those skilled in the art may understand that such specificity with respect to sequence is not actually required. It may also be understood that the terms and expressions used herein may be defined with respect to their corresponding respective areas of inquiry and study except where specific meanings have otherwise been set forth herein.

FIG. 1 is a diagram illustrating an exemplary prior art practice of software development.

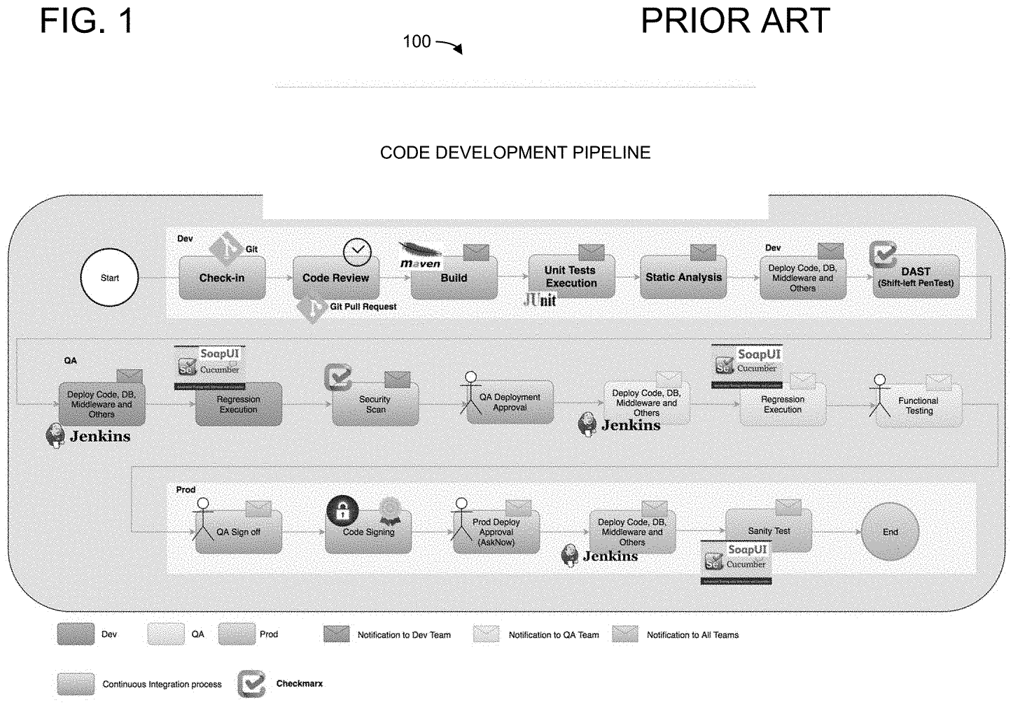

FIG. 2 is a diagram illustrating a data structure for measuring application maturity according to one embodiment.

FIG. 3 is a flow diagram illustrating scoring determination of a maturity of an application according to one embodiment.

FIG. 4 is a flow diagram illustrating a lifecycle of code development according to one embodiment.

FIG. 5 is a flow chart illustrating a method according to one embodiment.

FIG. 6 is a diagram illustrating a portable computing device according to one embodiment.

FIG. 7 is a diagram illustrating a computing device according to one embodiment.

### DETAILED DESCRIPTION

Embodiments may now be described more fully with reference to the accompanying drawings, which form a part hereof, and which show, by way of illustration, specific exemplary embodiments which may be practiced. These illustrations and exemplary embodiments may be presented with the understanding that the present disclosure is an exemplification of the principles of one or more embodiments and may not be intended to limit any one of the embodiments illustrated. Embodiments may be embodied in many different forms and should not be construed as limited to the embodiments set forth herein; rather, these embodiments are provided so that this disclosure may be thorough and complete, and may fully convey the scope of embodiments to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Embodiments may create a system to determine, monitor and analyze application code quality. Aspects of embodiments create a data structure that not only is designed to store the content (or a pointer to a data storage location) of the code or application, but also data fields for storing additional related or associated data of the application for application code quality analysis and score. In another embodiment, aspects of embodiments provide an unbiased code quality performance evaluation to a development manager. The report or the GUI generated may be used as a tool to reward individuals whose code quality measurements exceeds the given thresholds, and perform root cause analysis with individuals whose code quality measurements are falling below the given thresholds.

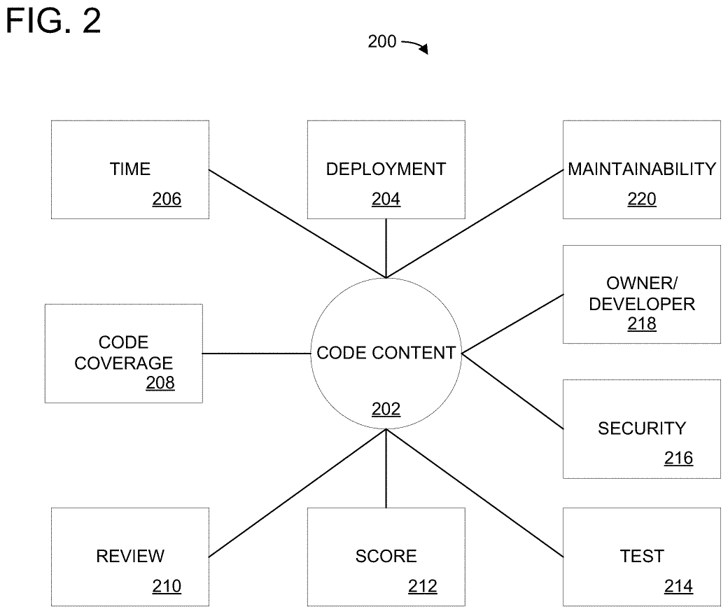

Referring to FIG. 2, a data structure 200 further illustrates one embodiment. For example, the data structure 200 may include the following data fields for storing data, parameters, values, etc. For example, the data structure 200 may include a first field or storage unit 202 for storing content or data related to the code. For example, the first field 202 may store the code in a database. In another embodiment, the first field 202 may store a pointer or reference data to the actual storage location of the code. In another embodiment, the data field 202 may store a name or description of the code. The data structure 200 may further include a second field 204 for storing deployment related data. For example, the second field 204 may include data such as deployment schedule, number of releases, deployment status, a number of deployment, etc.

The data structure 200 may also include a third field 206 for storing time related data, such as time of creation of the code, time of the check-in to the repository, build time, time of updates, time of deployment, time of a previous deployment, test time, release year, time for bug fixes, time for redeployment, time for removal of errors, etc. The data structure 200 may include a fourth field 208 for storing code coverage data, such as technology involved or used by the code, the application used or involved with the code, business entity involved with the code, projects related to the code, service application used or involved with the code, any branch of the code, etc. The data structure 200 may also include a fifth field 210 for storing review data, which may include return of investment (ROI) parameters, various statistical analysis parameters or settings (e.g., checkmarx statistics, Static Code analysis data capture, GIT statistics, etc.), recommendation information for improvements, suggestions, etc. The data structure 200 may include a sixth field 212 for storing score related data, such as a build & deploy score or percentage, a code quality score, a security score, a code coverage score, a test average score, a code quality score, etc.

The data structure 200 may also include a seventh field 214 for storing test related data, such as number of test, test execution time, test type, test number, test results, etc. The data structure 200 may further include an eighth field 216 for storing scan results data. The data structure 200 may further include a ninth field 218 for storing data relating to the name, identification, contact information, etc., of the developer or owner of the code. In another embodiment, the field 218 may store other owner/developer information such as supervisor of the code project, etc. In another embodiment, the owner/developer field 218 may also include names of co-developers, etc. Furthermore, the data structure 200 may include a tenth field 220 for storing data relating to maintainability. For example, maintainability measures may include how difficult it is to maintain the portion of the code or the code after deployment. Factors may consider a function of the amount of time for the deployment and post-deployment bug fixes or hot fixes.

In one embodiment, some of the information in the data structure 200 may be populated or filled automatically. For example, when a developer is logged into a system to start working on writing code or application programs, the developer may interface with a graphical user interface (GUI) to onboard the application on the embodiment. The developer may create code and check-in to the code repository. As soon as the code is checked-in, the software development lifecycle (SDLC) pipeline may begin and the data structure 200 may automatically, continuously, update various fields, such as time, code coverage, review, code content, etc.

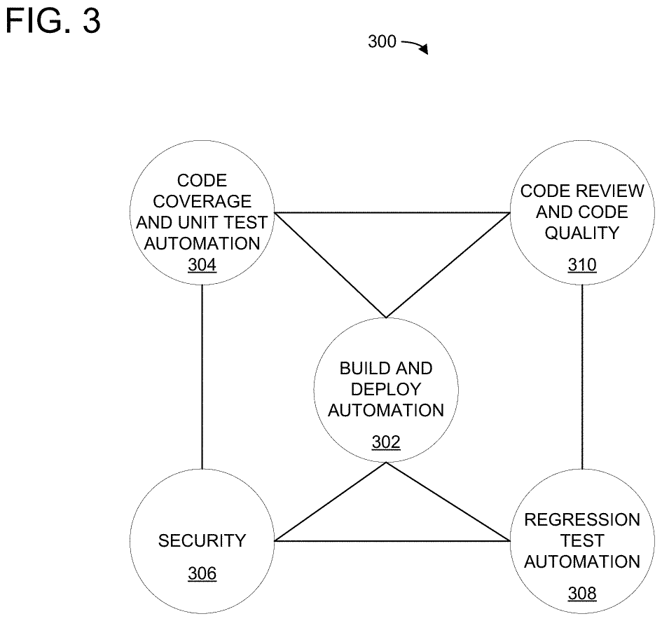

With such data structure 200, aspects of embodiments may expose the data in the fields to further interface and processing. Referring now to FIG. 3, a diagram 300 illustrates five system drivers of an application code quality determination according to one embodiment. For example, the application code quality determination system may include components or modules such as a build and deploy automation component 302, a code coverage and unit test automation component 304, a security component 306, a regression test automation component 308, and a code review and code quality component 310. These components utilize the data structure 200 to provide the code quality score of the code or application developed by the developer. In one embodiment, these five components have been identified to improve the release agility, reduce security risks, and improve code quality that may improve and result in defect free products. In one aspect, these components include automated features and may automatically measure the progress of automation for each application based on the data structure 200 built for the code.

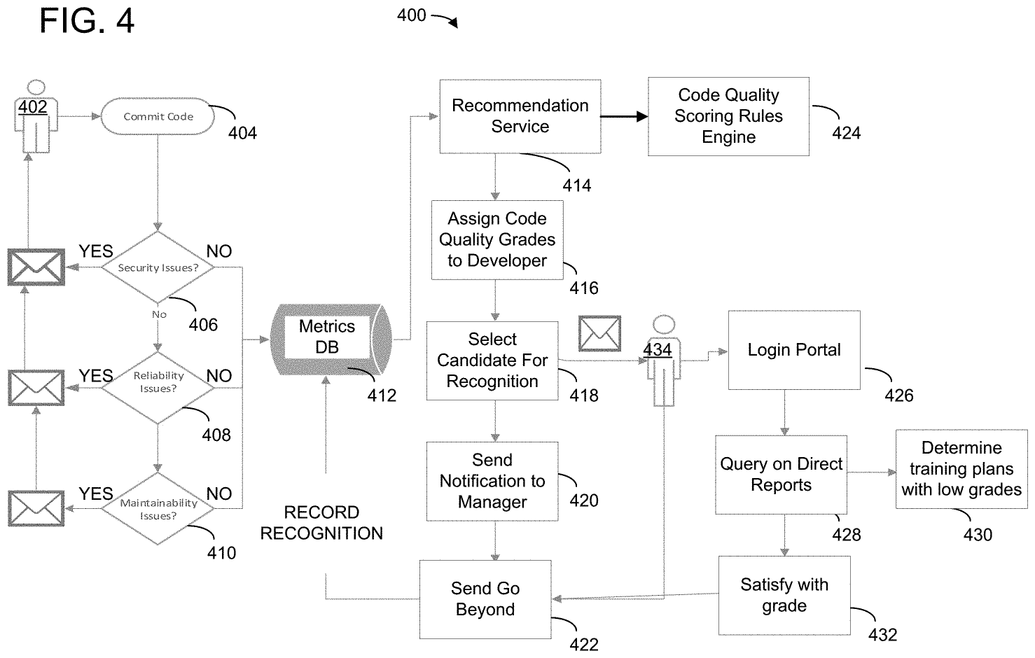

Moreover, FIG. 4 may illustrate another diagram 400 showing how the code quality grade or value may be derived. In one aspect, the diagram 400 may illustrate a typical code or application software development. For example, a developer 402 may begin by committing code or a portion of codes at 404. An automated system or a manual determination may begin to determine whether there is any security issue at 406, any reliability issue at 408, or any maintainability issue at 410. In one example, maintainability issues may include how difficult is to maintain the portion of the code or the code after deployment. Such issue may not have caught during the testing, etc.

In one aspect, once these issues are identified, the developer 402 may be notified, via email or other communication means. Otherwise, the code or the portion of the code is considered to have certain quality. As such, the code is stored into the metrics database 412 based on the data structure 200. In another embodiment, the results of the evaluations, such as security issues, reliability issues, or maintainability issues are stored in the database 412 as well. At 414, a recommendation service may begin, which may receive input from a code quality scoring rules engine 424.

The recommendation service 414 may assign a code quality grade to a developer, such as the developer 402, at 416; select a candidate for recognition or recommendation at 418; send a notification to a manager at 420. A manager 434 may receive a notification from the recommendation service and he or she may login to his or her portal 426 to review and check on the evaluations. In another embodiment, the manager 434 perform a query to identify the different grades for the developers at 428. The manager 434 may either satisfy with the grades at 432 or he/she may determine a remedial plan or training plan for those developers with lower grades.

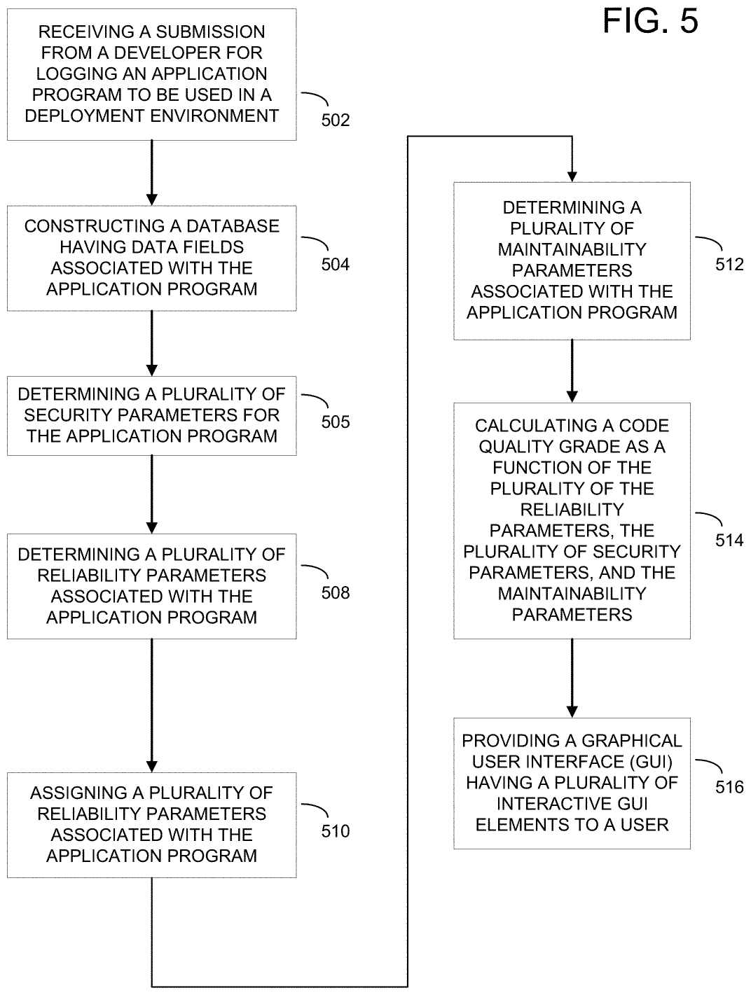

Referring now to FIG. 5, a flow chart illustrating a method according to one embodiment. At 502, the system (e.g., application code quality system) may receive a submission from a developer for logging an application program to be used in a deployment environment. In one embodiment, the submission may include a portion or a part of the application program. For example, the developer may save or store a portion of the code or application as he or she continues to develop the code. At 504, the system may construct a database having data fields associated with the application program. In one embodiment, the database includes a data structure (e.g., data structure 200) for the code or the application program. In another embodiment, the data fields comprising at least one of the following: a development status associated with the application program, a technology identification associated with the application program, features associated with the application program, services in the deployment environment associated with the application program, and a maturity score for the application program. As illustrated in FIG. 2, the data structure 200 may have one or more fields for storing at least one of the data.

At 506, the system may determine a plurality of security parameters for the application program, and at 508, may determine a plurality of reliability parameters associated with the application program at 510. The system may further determine a plurality of maintainability parameters associated with the application program at 512.

At 514, the system may calculate a code quality grade as a function of the plurality of the reliability parameters, the plurality of security parameters, and the maintainability parameters. At 516, the system may provide a graphical user interface (GUI) having a plurality of interactive GUI elements to a user.

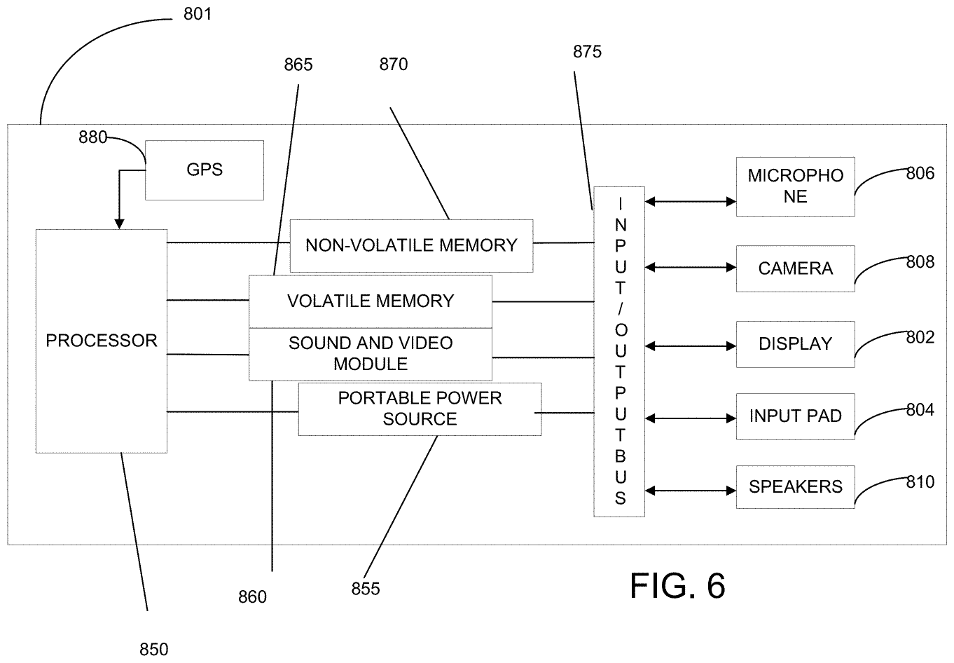

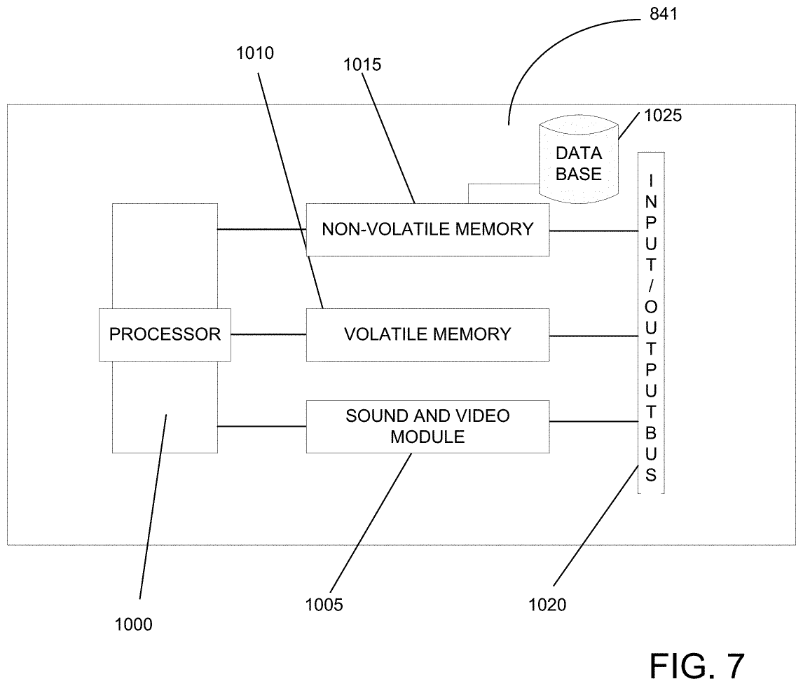

FIG. 6 may be a high level illustration of a portable computing device 801 communicating with a remote computing device 841 in FIG. 7 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 108 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi® (802.11 standard), BLUETOOTH, cellular communication or near field communication devices. The communication may be direct to the computing device 841 or may be through a communication network 102 such as cellular service, through the Internet, through a private network, through BLUETOOTH, etc., FIG. 6 may be a simplified illustration of the physical elements that make up a portable computing device 801 and FIG. 7 may be a simplified illustration of the physical elements that make up a server type computing device 841.

FIG. 6 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have non-volatile memory 865 and volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc., It also may control of communicating with the networks, either through wireless or wired devices. Of course, this is just one embodiment of the portable computing device 801 and the number and types of portable computing devices 801 is limited only by the imagination.

The physical elements that make up the remote computing device 841 may be further illustrated in FIG. 7. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc., The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be computers that may have, among other elements, a microprocessor (such as from the Intel® Corporation, AMD®, ARM®, Qualcomm®, or MediaTek®); volatile and non-volatile memory; one or more mass storage devices (e.g., a hard drive); various user input devices, such as a mouse, a keyboard, or a microphone; and a video display system. The user devices, computers and servers described herein may be running on any one of many operating systems including, but not limited to WINDOWS®, UNIX®, LINUX®, MAC® OS®, iOS®, or Android®. It is contemplated, however, that any suitable operating system may be used for the present invention. The servers may be a cluster of web servers, which may each be LINUX® based and supported by a load balancer that decides which of the cluster of web servers should process a request based upon the current request-load of the available server(s).

The user devices, computers and servers described herein may communicate via networks, including the Internet, wide area network (WAN), local area network (LAN), Wi-Fi®, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of embodiments may become apparent to those skilled in the art upon review of the disclosure. The scope embodiments should, therefore, be determined not with reference to the above description, but instead should be determined with reference to the pending claims along with their full scope or equivalents.

One or more features from any embodiment may be combined with one or more features of any other embodiment without departing from the scope embodiments. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it may be understood by those of ordinary skill in the art having the present specification, figures and claims before them, that the corresponding structure includes a computer, processor, or microprocessor (as the case may be) programmed to perform the particularly recited function using functionality found in a computer after special programming and/or by implementing one or more algorithms to achieve the recited functionality as recited in the claims or steps described above. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one embodiments to the embodiments illustrated.

The present disclosure provides a solution to the long-felt need described above. In particular, the systems and methods overcome challenges of code development by creating and generating a code quality grade for the developers. Based on the grade, the system administrator may provide various kinds of rewards or incentives to encourage increasing or maintaining of the code quality grade from the developers.

Further advantages and modifications of the above described system and method may readily occur to those skilled in the art.

The disclosure, in its broader aspects, is therefore not limited to the specific details, representative system and methods, and illustrative examples shown and described above. Various modifications and variations may be made to the above specification without departing from the scope or spirit of the present disclosure, and it is intended that the present disclosure covers all such modifications and variations provided they come within the scope of the following claims and their equivalents.

What is claimed is:

1. A software code quality monitoring method comprising:
receiving a submission from a developer for logging an application program to be used in a deployment environment;
constructing a database having data fields associated with the application program, said data fields comprising at least one of the following: a development status associated with the application program, a technology identification associated with the application program, features associated with the application program, services in the deployment environment associated with the application program, and a maturity score for the application program;
determining a plurality of security parameters for the application program;
determining a plurality of reliability parameters associated with the application program;
determining a plurality of maintainability parameters associated with the application program;
calculating a code quality grade as a function of the plurality of the reliability parameters, the plurality of security parameters, and the maintainability parameters; and
providing a plurality of interactive graphical user interface (GUI) elements to a user.

2. The software code quality monitoring method of claim 1, further comprising retrieving rules from code quality scoring engine.

3. The software code quality monitoring method of claim 1, further comprising determining a threshold of the code quality grade to be rewarded.

4. The software code quality monitoring method of claim 3, further comprising recording, based on the user, a history of code quality grades.

5. The software code quality monitoring method of claim 4, further comprising sending a notification the user in response to detecting one of the code quality grades in the history is below the threshold.

6. The software code quality monitoring method of claim 5, further comprising providing from the user a feedback to the one of the code quality grades.

7. A system comprising:
a database for storing one or more portions of an application program;
a server configured for executing computer-executable instructions for:
receiving a submission from a developer for logging at least one portion an application program to be used in a deployment environment;
constructing a database having data fields associated with the at least one portion application program, said data fields comprising at least one of the following: a development status associated with the application program, a technology identification associated with the application program, features associated with the application program, services in the deployment environment associated with the application program, and a maturity score for the application program;
determining a plurality of security parameters for the at least one portion application program;
determining a plurality of reliability parameters associated with the at least one portion application program;
determining a plurality of maintainability parameters associated with at least one portion the application program;
calculating a code quality grade as a function of the plurality of the reliability parameters, the plurality of security parameters, and the maintainability parameters; and
providing a plurality of interactive graphical user interface (GUI) elements to a user.

8. The system of claim 7, further comprising retrieving rules from code quality scoring engine.

9. The system of claim 7, further comprising determining a threshold of the code quality grade to be rewarded.

10. The system of claim 9, further comprising recording, based on the user, a history of code quality grades.

11. The system of claim 10, further comprising sending a notification the user in response to detecting one of the code quality grades in the history is below the threshold.

12. The system of claim 11, further comprising providing from the user a feedback to the one of the code quality grades.

13. A tangible non-transitory computer-readable medium having stored thereon computer-executable instructions for calculating a code quality grade comprising:
receiving a submission from a developer for logging at least one portion an application program to be used in a deployment environment;
constructing a database having data fields associated with the at least one portion application program, said data fields comprising at least one of the following: a development status associated with the application program, a technology identification associated with the application program, features associated with the application program, services in the deployment environment associated with the application program, and a maturity score for the application program;
determining a plurality of security parameters for the at least one portion application program;
determining a plurality of reliability parameters associated with the at least one portion application program;
determining a plurality of maintainability parameters associated with at least one portion the application program;
calculating a code quality grade as a function of the plurality of the reliability parameters, the plurality of security parameters, and the maintainability parameters; and
providing a plurality of interactive graphical user interface (GUI) elements to a user.

14. The tangible non-transitory computer-readable medium of claim 13, further comprising retrieving rules from code quality scoring engine.

15. The tangible non-transitory computer-readable medium of claim 13, further comprising determining a threshold of the code quality grade to be rewarded.

16. The tangible non-transitory computer-readable medium of claim 15, further comprising recording, based on the user, a history of code quality grades.

17. The tangible non-transitory computer-readable medium of claim 16, further comprising sending a notification the user in response to detecting one of the code quality grades in the history is below the threshold.

18. The tangible non-transitory computer-readable medium of claim 17, further comprising providing from the user a feedback to the one of the code quality grades.
